(19) United States
(12) Patent Application Publication
(10) Pub. No.: US 2006/0000142 A1
(43) Pub. Date: Jan. 5, 2006

(54) Precise oxygen to carbon ratio control in oxidation reformers

(76) Inventors: Jingyu Cui, Glastonbury, CT (US); Eric A. Rohrbach, Lebanon, CT (US); Peter F. Foley, Manchester, CT (US); Timothy J. Crowley, Tolland, CT (US); John A. Trela, Cincinnati, OH (US)

Correspondence Address: M. P. Williams;Patent Counsel, 210 Main Street, Manchester, CT, 06040, US

(21) Appl. No.: 10/882,912

(22) Filed: Jun. 30, 2004

(51) Int. Cl. B01J 8/00

(52) U.S. Cl. 48/127.9

(57) ABSTRACT

An autothermal reformer or a catalytic partial oxidizer (19) receives flow of desulfurized hydrocarbon fuel from a hydrogen desulfurizer (HDS) (15) through an orifice (13a). A differential pressure transducer (13b) provides a signal (24a) to a fuel-flow differential-pressure schedule (13c) to provide a fuel flow signal (24b) which is (25) subtracted from fuel command (26), to provide a valve position signal 30a from a proportional/integral gain (29), being linearized (58) to control the fuel valve (12). The minimum (59) of actual fuel flow (24b) and fuel flow command (59) is applied to an air/fuel schedule (33). The resulting air flow command is compared with actual air flow (41b) to provide an air flow control signal 48a which is linearized (60) after proportional/integral gain (47) to provide air flow command (48b) to a blower (49). Differential pressure (42b) across an orifice (42a) is provided to a schedule (42c) which converts to the actual air flow feedback (41b). A laminar flow restriction (42b) may be warmed by a CPO (19).

### TECHNICAL FIELD

This invention relates to precise and reliable control of oxygen to carbon ratio in a catalytic partial oxidizer reformer (CPO) or an autothermal reformer (ATR), determining air and fuel flow rates in close proximity to the reformer, compensating for non-linear fuel or air flow versus fuel or air valve position and non-linear air flow versus air blower speed, and preventing water condensation corruption of flow measurements.

### BACKGROUND ART

It is well known that catalytic partial oxidation reformers (CPOs) and autothermal reformers (ATRs) typically utilized to produce hydrogen-rich gas, referred to as “reformate”, require precise control of oxygen to carbon ratio in the fuel gas, and must have the level of sulfur therein reduced to below about 25 parts per billion by volume (ppbv) in order to avoid sulfur poisoning of the catalysts in subsequent fuel processing reactors to provide low COX gas called “syngas”.

As is known, the ratio of oxygen to carbon in a CPO should be about 0.62. Ratios higher than about 0.65 lead to higher temperature and resulting catalyst damage and causes reduced hydrogen concentration; ratios of less than 0.50 lead to reduced hydrogen production as well as elevated levels of methane.

Maintaining this ratio is extremely difficult during transients, that is, when there are increases or decreases in the fuel flow command. As an example, an increased fuel flow ahead of a hydrogen desulfurizer (HDS) will not show up downstream of the HDS immediately, since much of the initial increase in flow is absorbed in pressurizing the HDS due to its large volume. Therefore, a flow transmitter ahead of the HDS will be indicating to the air flow channel a higher flow of fuel than is actually reaching the CPO. This will cause a higher O₂/C ratio in the CPO and thus reduced production of hydrogen in the CPO and possibly damage the CPO catalyst; conversely in a down transient of fuel flow.

Another hindrance to maintaining a proper O₂/C ratio is the susceptibility of flow transducers to water condensation. Turbine type flow transducers have a tendency to drag causing false low flow indications, particularly in the presence of moisture, and they tend to “free-wheel” during down transients, due to inertia, causing false high flow indications. In an air flow path, moisture is always present and tends to condense on the air flow transducer. The air flow control responds to this false decrease in air flow indication by increasing the blower speed, resulting in excessive O₂, CPO catalyst overheating, and possible catalyst damage.

Moisture also confounds thermal dispersion type flow meters; vortex-shedding type meters are not stable during fast transients. In short, no measurement technology has demonstrated the ability to accurately measure fuel and air flows during fast transients in the presence of moisture.

### DISCLOSURE OF INVENTION

Objects of the invention include: more precise and reliable control of oxygen to carbon ratio in a hydrocarbon fuel reforming system employing an HDS; more precise and reliable control over the flow of fuel and air in a hydrocarbon fuel reformer; longer CPO and ATR catalyst life as a consequence of improved O₂/C control; reduction of excessive oxygen as a consequence of fuel transients; improved tracking of air flow as a function of fuel flow in a reformer; more precise and reliable measurement of air flow and fuel flow in a reformer; ensuring that the fuel/air mix is fuel-rich during increasing fuel or decreasing fuel transients and improved control of hydrogen and carbon monoxide concentrations in the reformate produced by a hydrocarbon fuel reformer.

This invention is predicated in part on the realization that the 10 flow of fuel provided to a hydrocarbon fuel reformer such as a CPO or an ATR, and the commensurate amount of air flow, should be measured in as close proximity to the entrance of the reformer as possible. The invention is predicated in part on the realizations that the flow of fuel or air through a fuel or air valve is not a linear function of the positioning of the valve and that the flow of air produced by a blower is not a linear function of the speed of the blower. This invention is also predicated in part on the realization that water condensation from humidified air corrupts conventional air flow measurements.

According to the present invention, in a hydrocarbon fuel reformer system employing a reformer, such as a CPO or an ATR, the flow of fuel, used to determine the commensurate flow of air, is measured by a differential pressure sensor responsive to fuel flow changes at the inlet of the reformer. In accordance with the invention in one form, the flow is determined by a differential pressure transducer connected across a small orifice or laminar restriction for better resolution of flow in fuel flow transients. In another form, the invention measures fuel flow as a function of pressure drop across the HDS.

In accordance with the invention, the flow of air to the hydrocarbon fuel reforming system employing a CPO or ATR is determined by a differential pressure transducer responsive to air flow changes in close proximity to the reformer. In accordance with the invention in one form, the flow is determined by a differential pressure transducer connected across a small orifice or laminar flow restriction in the air flow between the air blower and the reformer. In another form, the invention measures air flow by a differential pressure transducer across a small orifice or laminar flow restriction that is fabricated as an integral part of the reformer air inlet. In this form, the orifice or laminar restriction will become heated by conduction of heat from the reformer vessel and will thereby resist water condensation from humidified air.

According to another aspect of the invention, the fuel flow command is adjusted to accommodate the non-linearity between the amount of fuel flow through a valve as a function of the position of the valve; this is applicable also to air flow when a valve is used to control air. In further accord with this aspect of the invention, an air blower command is compensated to accommodate the lack of linearity in the volume of air which a blower will provide as a function of the speed of the blower.

According further to the invention, differential pressure is measured across a flow restraint disposed integrally with the inlet of a hydrocarbon fuel reformer, in close thermal communication therewith.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a simplified functional schematic diagram illustrating a first generation of a CPO reformer being fed air and hydrocarbon fuel through an HDS, employing aspects of the invention.

FIG. 2 is a simplified functional schematic diagram of a CPO reformer receiving fuel from an HDS, employing additional aspects of the present invention.

FIG. 3 is a chart of fuel flow as a function of fuel valve position.

FIG. 4 is a chart of position command to the fuel valve as a function of the linearized fuel command.

FIG. 5 is a chart of air flow as a function of air blower speed.

FIG. 6 is a chart of speed command to an air blower as a function of the linearized air command.

FIGS. 7 and 8 are fragmentary diagrams of variants of FIG. 3.

FIGS. 9-11 are charts of hydrogen production, oxygen to carbon ratio, and carbon monoxide at the exit of a CPO, all as a function of time.

FIG. 12 is a side elevation cross section of a heated, laminar restriction of the invention.

### MODE(S) FOR CARRYING OUT THE INVENTION

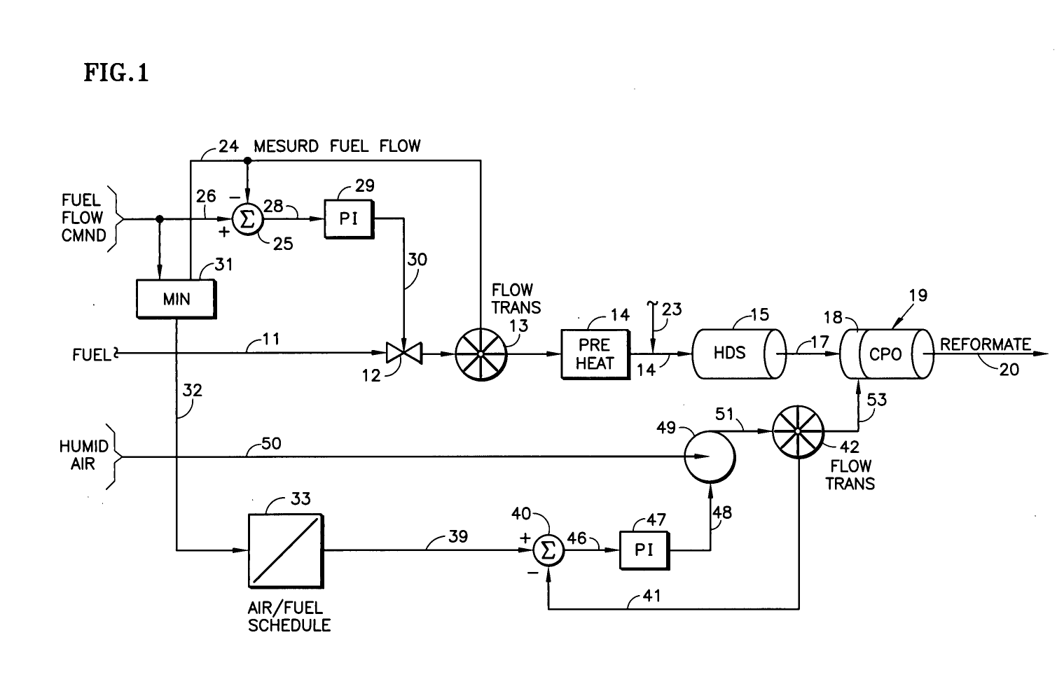

In a first generation of the invention shown in FIG. 1, hydrocarbon fuel, such as liquid petroleum gas or natural gas, flows in a conduit 11 through a valve 12 and a flow metering transducer 13, over a conduit to a fuel preheater 14 and then to a hydrogen desulfurizer (HDS) 15. The HDS typically will have a noble metal catalyst, such as platinum or palladium, on which sulfur compounds, such as thiophene, are reduced to hydrogen sulfide, which is then captured by a sorbent, such as zinc oxide. Low sulfur fuel is fed over a fuel flow path, such as a conduit 17, to the mixer 18 at the inlet of a reformer, such as a CPO 19 or an ATR, where it is mixed with a controlled flow of air in a conduit 53 (described hereinafter). The CPO output in a conduit 20 comprises reformate gas which, for methane feed stock, is roughly 37% hydrogen, 14% CO, 4% CO₂ and traces of other gases.

The reformate may be further processed, such as in a water-gas shift reactor and a preferential CO oxidizer to make syngas suitable for use, for instance, in a fuel cell. To make the hydrogen desulfurization process go forward, additional hydrogen is required in the HDS, which may be provided by the syngas resulting from the aforementioned downstream processing, such as in a line 23, as illustrated in copending U.S. patent application Ser. No. 10/731,291, filed Dec. 9, 2003. This forms no part of the invention and is not described further.

The flow transducer 13, which may comprise a turbine or other type of transducer, provides a signal on a line 24 as feedback to a summing junction 25, the positive input of which is a fuel flow command on a line 26. The error signal on a line 28 is provided to a proportional/integral gain 29, the output of which on a line 30 controls the positioning of the valve 12. So long as the flow indicated by the flow transducer 13 is the same as the flow dictated by the fuel flow command on the line 26, the valve will not be moved. Any variation in the fuel flow from the commanded amount will cause a commensurate adjustment in the position of the valve 12.

To ensure that conservative amounts of oxygen are always commanded as described hereinbefore, a minimum selecting function 31 selects the least of the fuel flow command on line 26 and the actual fuel flow on line 24 to apply over a line 32 to a fuel/air schedule 33 which is a fixed indication of the amount of air required for the amount of fuel flowing in order to provide the correct oxygen-to-carbon ratio. Thus, during an up-transient in the fuel flow command, the air fuel schedule will respond to the actual fuel flow, which will be lower than the command. During a down-transient, the schedule 33 will respond to the command, which will be lower than the actual flow. The output of the schedule 33 on a line 39 is applied to a summer 40, the negative input of which is on a line 41 from an air flow transducer 42, which may also be of the turbine or other type. The air flow error signal on a line 46 is provided to a proportional/integral gain 47, the output of which on a line 48 controls the speed of an air blower 49, which receives humidified air over a conduit 50. The output of the flow transducer 42 passes to the mixer 18 of the CPO 19 in an air flow path, such as a conduit 53.

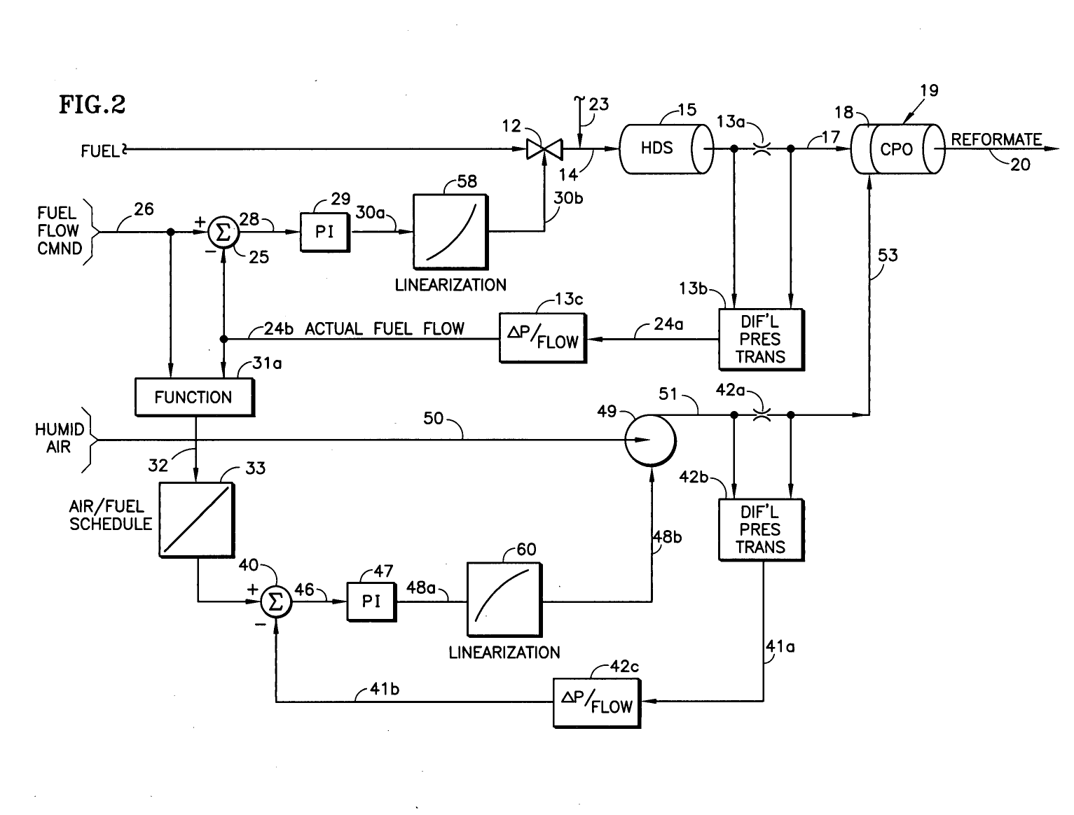

Referring to FIG. 2, according to a major aspect of the present invention, pressure indicative of fuel flow is measured at the inlet to the CPO 19. Because the temperature downstream of the HDS 15 is on the order of 350° C. (662° F.), traditional flow meters, such as a turbine flow meter 13 (FIG. 1), cannot be utilized because they would be damaged by the heat. Therefore, a small laminar flow restriction, venturi or orifice 13a is provided and a differential pressure transducer 13b provides a signal on a line 24a indicative of the difference in pressure on opposite sides of the orifice 13a. A schedule 13c of fuel flow as a function of pressure differential provides a signal on a line 24b indicative of flow through the orifice.

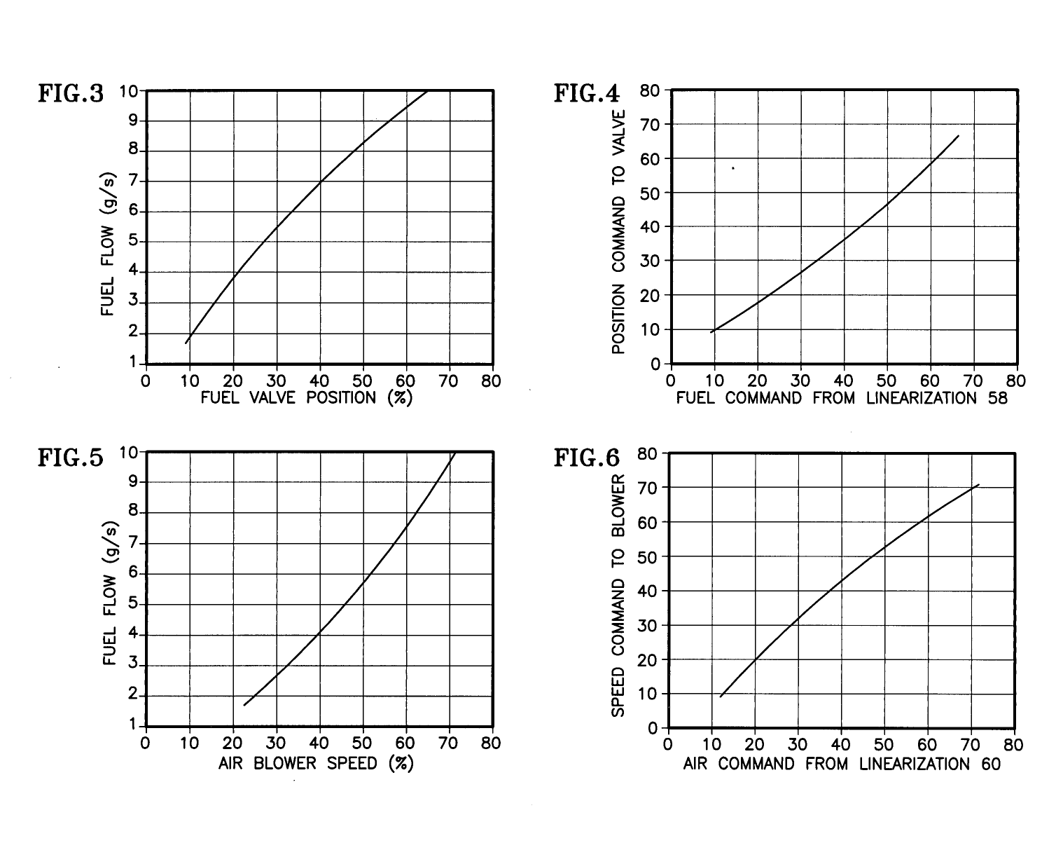

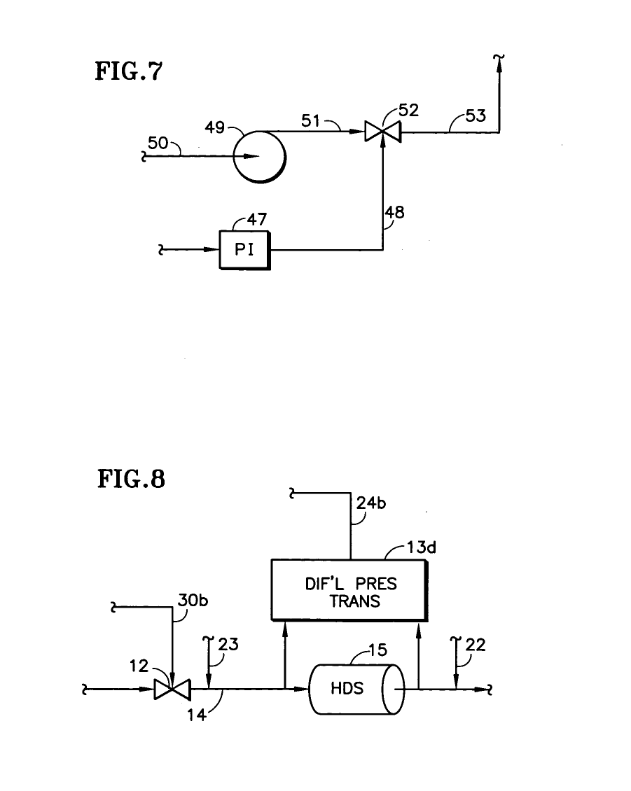

Another aspect of the present invention is illustrated in FIGS. 3 and 4. In FIG. 3, the fuel flow in grams per second is plotted as a function of fuel valve position. It is readily apparent that at the more open fuel valve positions, there is a smaller incremental flow of fuel per incremental increase in position. To compensate for that, a linearization function 58 (FIG. 4) provides a position command to the valve 12 as a function of fuel command from the PI function 29, as illustrated. That is, for higher fuel commands the position commands are incrementally greater. Stated alternatively, the concave up gain command of FIG. 4 compensates for the concave down flow/position relationship of FIG. 3. The net result is that the fuel flow is a linear function of the valve position command. Although illustrated in FIG. 2 as a separate function 58, the linearization may be accomplished together with the proportional/integral gain 29 in a single function using gain scheduling.

If desired, the schedule 33 may be made responsive to some selected function 31a, other than the minimum selecting function 31 depending on the application of the invention. Or, it could be just the fuel flow command on line 26 if desired, while utilizing other aspects of the invention; this results in faster air response because the air controller does not wait for measured changes in the fuel flow. This approach requires that the integral and proportional gains of PI 29 and PI 47 are tuned to give about the same setpoint tracking (servo) response, which can provide very tight control of oxygen to carbon ratios on both up transients and down transients.

According to the invention, the non-linear relationship of air flow as function of air blower speed is illustrated in FIG. 5. Therefore, a linearization function 60, has a gain of speed command to the blower on the line 48b, as a function of air command from the proportional integral function 47 on the line 48, as is illustrated in FIG. 6. Thus, the concave down linearization of FIG. 6 compensates for the concave up air flow versus air blower speed of FIG. 5. In other embodiments as shown in FIG. 8, the air flow may be controlled by a valve, in which case linearization may be as described with respect to FIGS. 3 and 4.

In FIG. 2, a small venturi or orifice 42a is provided with a differential pressure transducer 42b feeding a schedule 42c to provide the air flow signal on the line 41a. This is in accordance with another aspect of the invention, which eliminates the inaccuracies of turbine and other type flow meters.

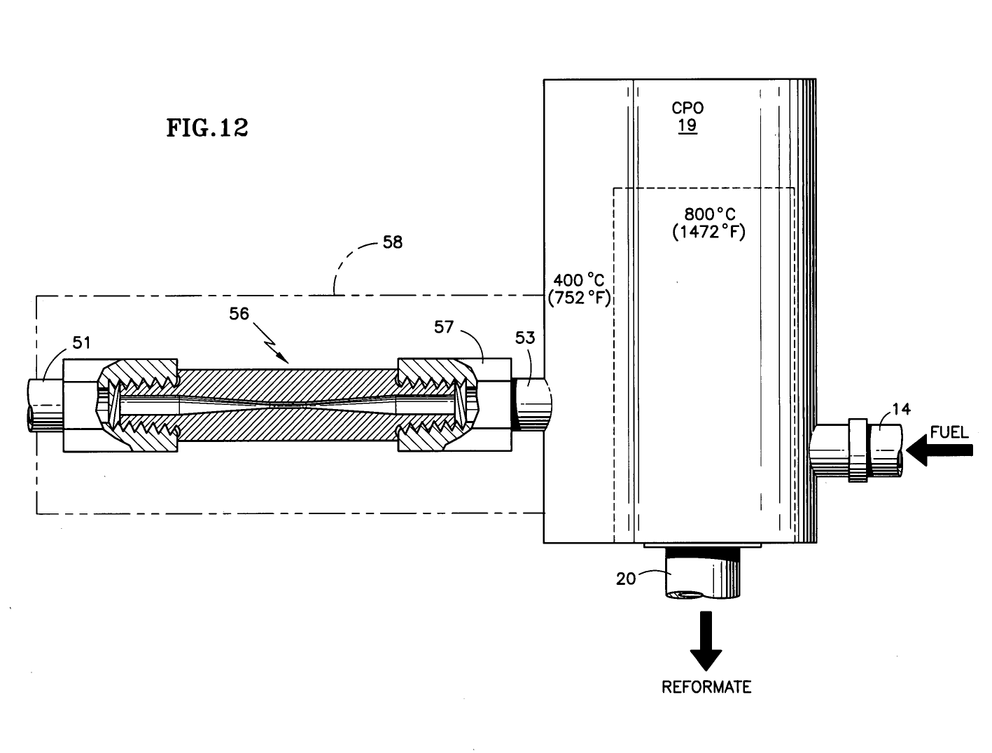

As illustrated in FIG. 8, instead of sensing the fuel pressure differential across the orifice 13a, the fuel pressure differential may be sensed by a transducer 13d across the hydrogen desulfurizer 15, if desired. However, measurement with the orifice 13a, as seen in FIG. 2 or laminar flow restriction, described with respect to FIG. 12, are preferred.

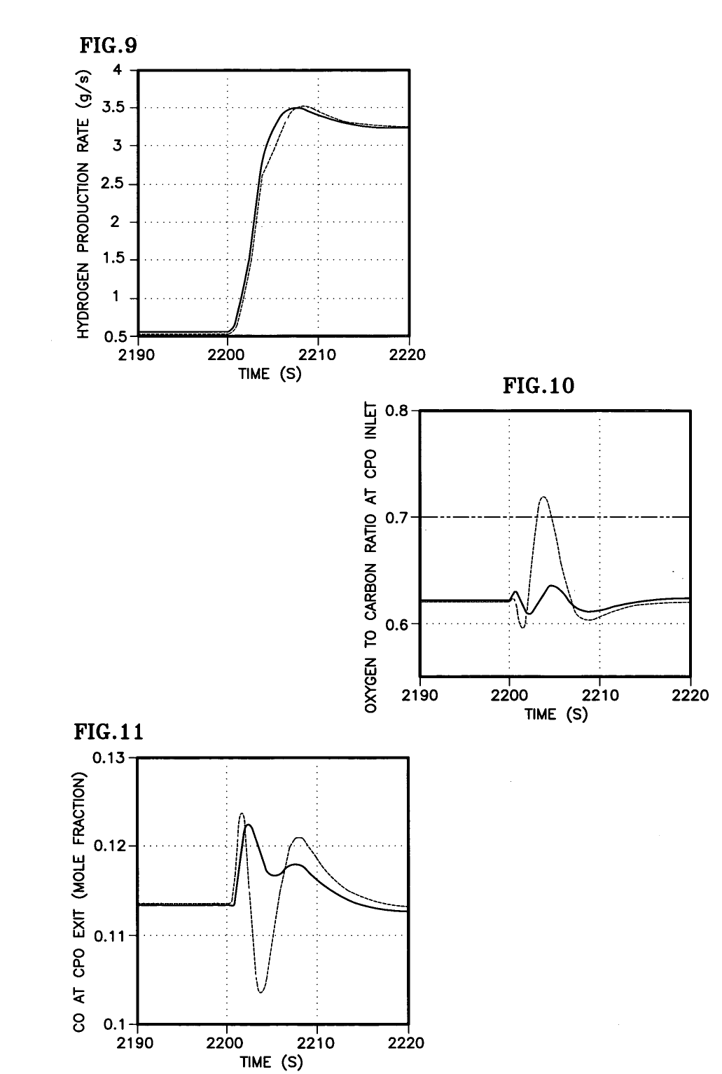

In FIGS. 9-11, performance of FIG. 1 is illustrated in dotted lines and performance of the invention, FIG. 2, is illustrated in solid lines. FIGS. 9-11 compare hydrogen production, oxygen-to-carbon ratio, and CPO exit CO, respectively. The illustrations refer to hydrogen production demanded by a load-following fuel cell power plant as the fuel cell power plant responds to a load increasing at about 20 kilowatts per second, from about 30 kW electric power output to about 150 kW electric power output of the fuel cell. FIG. 9 illustrates that there is a slight increase in hydrogen production during the first five seconds of the transient, which is the most critical time period for load-following fuel cell power plants.

The most notable benefit of the invention is illustrated in FIG. 10, where the oxygen/carbon ratio is seen to not vary by more than about 0.01. This is in contrast with an unacceptably excessive ratio of about 0.72 when the features of the invention are not employed. FIG. 1 2 illustrates that the maximum peak in the production of carbon monoxide during the transient is slightly less with the invention than in the prior art.

In another aspect of the invention, the air flow is measured by measuring pressure drop across an orifice or laminar flow restriction that is integrated with the CPO air inlet. This will heat the orifice or laminar flow restriction and prevent water condensation and associated corruption of air flow measurements. In FIG. 12, a laminar flow restriction 56 is threaded into a flange 57 of the CPO 19, and provided with insulation 58. This keeps the laminar flow restriction 56 at a sufficiently high temperature to eliminate (or nearly so) condensation which would otherwise corrupt flow measurements. The orifice 13a (FIG. 2) could be so disposed.

The aforementioned patent application is incorporated herein by reference.

Thus, although the invention has been shown and described with respect to exemplary embodiments thereof, it should be understood by those skilled in the art that the foregoing and various other changes, omissions and additions may be made therein and thereto, without departing from the spirit and scope of the invention.

We claim:

1. A system for producing hydrogen-containing reformate from hydrocarbon fuel, comprising:
a source of hydrocarbon fuel;
a reformer selected from (a) a catalytic partial oxidizer (CPO) and (b) an autothermal reformer (ATR);
a hydrogen desulfurizer (HDS) receiving fuel from said source and providing reduced-sulfur fuel to said reformer;
a first gas valve in which the flow of gas therethrough is a non-linear function of the position of said valve, for controlling the amount of fuel flowing through said HDS;
a fuel flow sensor including a differential pressure transducer for providing a fuel pressure signal indicative of the difference in pressure either (a) across a flow restraint selected from (i) a venturi, (ii) an orifice, and (iii) a laminar restriction, or (b) across said HDS, and a schedule responsive to said fuel pressure signal to provide an actual fuel flow signal indicative of the flow of fuel into said reformer;
a first function responsive to said actual fuel flow signal and at least a fuel flow command signal to provide, to said first gas valve, a fuel valve control signal in response to which said valve will attain a position that provides flow of fuel which is a linear function of said fuel flow control signal;
a source of air;
an air flow controller selected from (c) a blower and (d) a second gas valve interconnected between said source of air and said reformer;
an air flow schedule responsive to the lesser of said fuel flow command signal and said actual fuel flow signal to provide an air flow control signal;
an air flow sensor including a differential pressure transducer for providing an air pressure signal indicative of the difference in pressure across an insulated flow restraint selected from (iv) a venturi, (v) an orifice, and (vi) a laminar restriction and disposed integrally with an air inlet of said reformer so as to be in close thermal communication therewith, and a schedule responsive to said air pressure signal to provide an air flow signal indicative of the flow of air into said reformer; and
a second function which is either (e) associated with said blower and responsive to said air flow control signal to provide to said blower a blower control signal in response to which said blower provides flow of air which is a linear function of said air flow control signal, or (f) associated with said valve and responsive to said air flow control signal to provide to said valve a valve control signal in response to which said valve provides a flow of air which is a linear function of said air flow control signal.

2. A linear gas flow control apparatus, comprising:
a flow controller selected from (a) a blower in which the flow of gas therethrough is a non-linear function of the speed of said blower, and (b) a valve in which the flow of gas therethrough is a non-linear function of the position of said valve;
a gas flow control signal:
a function which is either (c) associated with said blower and responsive to said gas flow control signal to provide to said blower a blower control signal in response to which said blower provides flow of gas which is a linear function of said gas flow control signal, or (d) associated with said valve and responsive to said gas flow control signal to provide to said valve a valve control signal in response to which said valve provides a flow of gas which is a linear function of said gas flow control signal.

3. A fuel flow sensor for sensing the flow of fuel into an inlet of a hydrocarbon fuel reformer, comprising:
a hydrocarbon fuel reformer;
a hydrogen desulfurizer (HDS) providing reduced-sulfur fuel to said reformer;
a differential pressure transducer for providing a pressure signal indicative of the difference in pressure either (a) across a restraint selected from (i) a venturi, (ii) an orifice, and (iii) a laminar flow restriction transmitting fuel from said HDS to said reformer, or (b) across said HDS: and
a schedule responsive to said pressure signal to provide an actual fuel flow signal indicative of the flow of fuel into said reformer.

4. A fuel flow sensor for sensing the flow of fuel into a fuel inlet of a hydrocarbon fuel reformer, comprising:
a hydrocarbon fuel reformer;
a flow restraint, selected from (i) a venturi, (ii) an orifice and (iii) a laminar flow restriction;
a differential pressure transducer for providing a pressure signal indicative of pressure across said flow restraint; and
a schedule responsive to said pressure signal to provide a fuel flow signal indicative of the flow of fuel into said reformer.

5. An air flow sensor for sensing the flow of air into an air inlet of a hydrocarbon fuel reformer, comprising:
a hydrocarbon fuel reformer;
a flow restraint, selected from (i) a venturi, (ii an orifice and (iii) a laminar flow restriction, and disposed integrally with an inlet of said reformer so as to be in close thermal communication therewith;
thermal insulation surrounding said flow restraint;
a differential pressure transducer for providing a pressure signal indicative of pressure across said flow restraint; and
a schedule responsive to said pressure signal to provide an air flow signal indicative of the flow of air into said reformer.

6. A system for producing hydrogen-containing reformate from hydrocarbon fuel, comprising:
a source of hydrocarbon fuel;
a reformer selected from (a) a catalytic partial oxidizer (CPO) and (b) an autothermal reformer (ATR);
a hydrogen desulfurizer (HDS) receiving fuel from said source and providing reduced-sulfur fuel to said reformer;
a first gas valve for controlling the amount of fuel flowing through said HDS;
a fuel flow sensor to provide an actual fuel flow signal indicative of the flow of fuel into said reformer;
a first function responsive to said actual fuel flow signal and at least a fuel flow command signal to provide, to said first gas valve, a valve position signal in response to which said valve will attain a position that provides flow of fuel which is a function of said valve position signal;
a source of air;
an air flow controller, selected from (c) a blower and (d) a second gas valve, interconnected between said source of air and said CPO;
an air flow schedule responsive to the lesser of (e) said fuel flow command signal and (f) said actual fuel flow signal to provide an air flow control signal;
an air flow sensor providing an air flow signal indicative of the flow of air to said reformer; and
a second function responsive to said air flow control signal and said air flow signal to provide to said air flow controller, an air flow control signal in response to which said air flow controller provides flow of air which is a function of said air flow control signal.
